(19) United States
(12) Patent Application Publication
(10) Pub. No.: US 2021/0250339 A1
(43) Pub. Date: Aug. 12, 2021

(54) SECURING COMMUNICATIONS VIA COMPUTING DEVICES

(71) Applicant: QUANTUM CLOAK, INC., Vienna, OH (US)

(72) Inventor: SEAN DAVID CHUMURA, Ellwood City, PA (US)

(21) Appl. No.: 17/168,438

(22) Filed: Feb. 5, 2021

Related U.S. Application Data
(60) Provisional application No. 62/970,858, filed on Feb. 6, 2020.

(51) Int. Cl. H04L 29/06; H04W 12/03; H04L 9/08; H04L 9/14; H04R 1/10; G06F 3/16

(52) U.S. Cl. CPC H04L 63/0457; H04W 12/03; H04L 9/08; H04R 2420/07; H04L 9/14; H04R 1/10; G06F 3/165; H04L 63/0492

(57) ABSTRACT

A secured communications device and associated methods provide confidential communications via computing devices. The secured communications device includes an audio input device, an audio output device, and a communications interface to communicatively couple the secured communications device with a computing device. The secured communications device encrypts audio received via the audio input device before transmission to the computing device and also receives audio from the computing device in encrypted form, which is decrypted before playback via the audio output device.

### CROSS-REFERENCE TO RELATED APPLICATIONS

This application is a non-provisional of and claims priority to U.S. Provisional Patent Application No. 62/970,858, filed on Feb. 6, 2020. The entirety of the aforementioned application is incorporated herein by reference.

### TECHNICAL FIELD

This application generally relates to secured devices and communications and, more particularly, to securing communications between parties carried out via conventional communications method, securing data communications between devices, and preventing unauthorized access to such data communicated between devices.

### BACKGROUND

With various electronic devices collecting, receiving, and transmitting data, privacy and confidentiality for personal information and corporate information is of the most importance. There are various applications and devices that attempt to provide secure communications but each have a deficiency or a weakness that is eventually exposed. Conventional techniques or computing devices leverage encryption and decryption for protection on voice, text, and/or file transfers. Yet, there still remains vulnerabilities when a malicious application is installed/transferred to a computing device and there is a reliance on third-party entities to secure private information.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

In one embodiment, a secured communications device is provided that may be communicatively coupled to a computing device to enable confidential communication with another party. The secured communications device includes an audio input device and an audio output device, and may utilize a short-range wireless communications protocol to couple with the computing device. Audio received via the audio input device is encrypted prior to transmission to the computing device for subsequent relaying to the other party in an encrypted format. Encrypted audio is also received from the computing device (e.g. from the other party). The encrypted audio is decrypted before playback via the audio output device.

In accordance with a further embodiment, a communication system is provided. The system includes a secure computing device electrically coupled to a secure link device, the secure link device being programmably linked solely for communications via a wireless transmission with a secure link device removeably coupled to a client computing device. The system further includes a secure link application hosted by the client computing device that disables a microphone, a speaker, and an application of the client computing device. The secure link device of the secure computing device employs a constructive key management (CKM) for encryption and authentication of data transmissions to or from the secure computing device. The secure link device of the secure computing device communicates CKM protected data to the secure link device of the client computing device. The client computing device utilizes a communication network to forward the CKM protected data.

These and other objects of this innovation will be evident when viewed in light of the drawings, detailed description and appended claims.

### BRIEF DESCRIPTION OF THE DRAWINGS

Various non-limiting embodiments are further described with reference the accompanying drawings in which:

FIG. 1 is a schematic block diagram of an exemplary, non-limiting embodiment of a communication system according to one or more aspects;

FIG. 2 is a schematic block diagram of an exemplary, non-limiting embodiment depicting inputs and outputs of a secured communications device according to various aspects;

FIG. 3 is a schematic block diagram of an exemplary, non-limiting embodiment of a secured communications device;

FIG. 4 is a flow diagram of an exemplary, non-limiting embodiment for providing confidential communications in accordance with various aspects;

FIG. 5 is an illustration of a secure communications system in accordance with the subject innovation;

FIG. 6 is a block diagram of data communications for a secure computing device in accordance with the subject innovation;

FIG. 7 is a block diagram of data communications a client computing device in accordance with the subject innovation;

FIG. 8 is a top rear perspective view of a secure link device;

FIG. 9 is a top front perspective view of the secure link device illustrated in FIG. 8;

FIG. 10 is a top view of the secure link device illustrated in FIG. 8, where the bottom view is a mirror-image thereto;

FIG. 11 illustrates an embodiment for a secure link device that enables a connection for charging;

FIG. 12 illustrates types of USB connections a secure link device can employ to allow connectivity to a computing device;

FIG. 13 illustrates embodiments of secure link devices;

FIG. 14 illustrates secure link devices coupling to various computing devices;

FIG. 15 illustrates a secure computing device coupled with a secure link device communicating with a client computing device with a coupled secure link device;

FIG. 16 is a schematic block diagram illustrating a suitable environment for delivery of data in accordance with the subject disclosure; and

FIG. 17 is a schematic block diagram illustrating illustrates a cloud computing environment in accordance with the subject innovation.

### DETAILED DESCRIPTION

While confidential communications may be possible with various computing devices such as mobile phones, conventional approaches require the computing devices themselves to be secured prior to conducting the communications. Without this initial setup, communications are not guaranteed to be confidential. Thus, confidential communications may not always be possible when an integrity of a computing device cannot be verified beforehand.

In various, non-limiting embodiments, a secured communications device and associated methods are provided to enable confidential communications via computing devices in a device-agnostic manner without requiring prior configuration of the computing devices themselves to ensure security. The secured communications device includes an audio input device (e.g. a microphone) and an audio output device (e.g. a speaker, earbud, or other electroacoustic transducer). The secured communications device also includes a communications interface to communicatively couple the secured communications device with a computing device. A communications session may be established via the computing device with a second computing device associated with another person. For instance, the communications session may be a VOIP call. The secured communications device encrypts audio received via the audio input device before transmission to the computing device to be conveyed via the communications session. Audio received over the communications session is also encrypted, transmitted to the secured communications device in encrypted form, and subsequently decrypted before playback via the audio output device.

With reference to the drawings, like reference numerals designate identical or corresponding parts throughout the several views. However, the inclusion of like elements in different views does not mean a given embodiment necessarily includes such elements or that all embodiments of the innovation include such elements. The examples and figures are illustrative only and not meant to limit the innovation, which is measured by the scope and spirit of the claims.

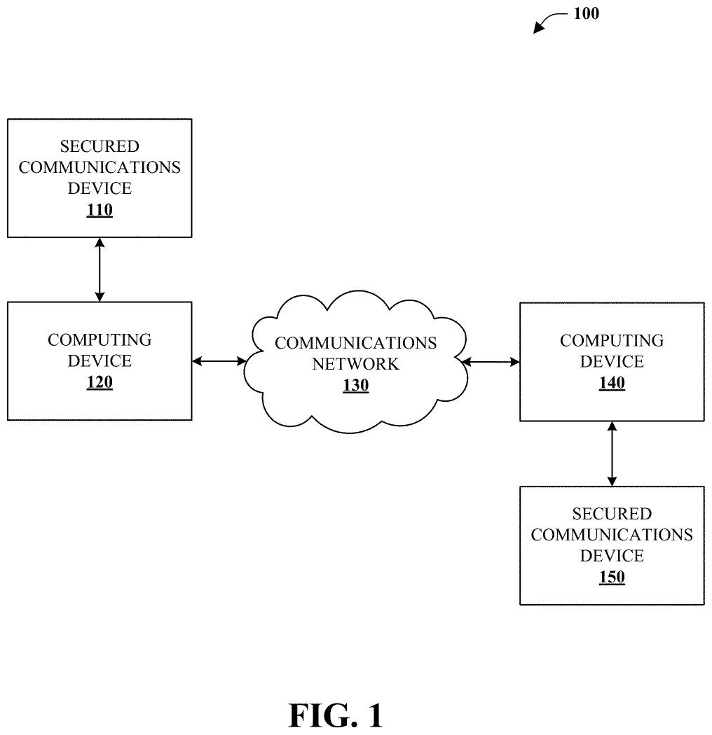

FIG. 1 shows a schematic block diagram of an exemplary, non-limiting embodiment of a communications system 100. System 100 can include a secured communications device 110 communicatively coupled to a computing device 120 and a second secured communications device 150 coupled to a second computing device 140. A communications session may be established between computing devices 120 and 140 via a communications network (e.g. the Internet, a wireless communications carrier network, a telephone network, a local area network, a wide area network, or combinations thereof). For instance, the communications sessions may be a voice call or a voice-over-IP (VOIP) call and may be established and carried out with conventional applications executed by computing devices 120 and 140.

According to various aspects, the communications session can be made confidential by using the secured communications devices 110 and 150. The devices 110 and 150 render the communication confidential without any modifications to the computing device 120, computing device 140, and/or communications network 130 to ensure the integrity or security thereof. Thus, any communications session can be conveniently made confidential. In a further aspect, the secured communications devices 110 and 150 may be implemented in a portable housing that is readily carried by a user and can be communicatively coupled with a variety of computing devices, as needed, to secure communications.

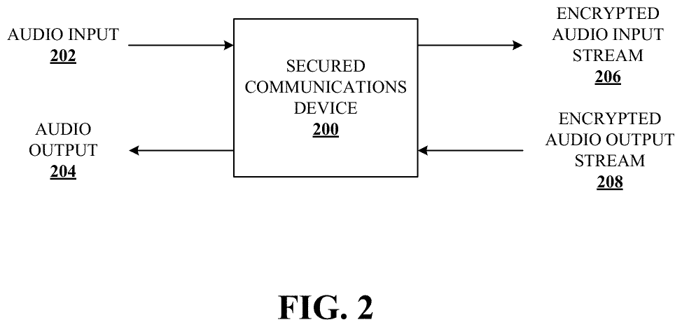

Turning briefly to FIG. 2, a secured communications device 200 is illustrated, which is similar to devices 110 and 150 from FIG. 1. As depicted in FIG. 2, device 200 enables confidential communications via substantially any computing device over substantially any communications networks regardless of whether those computing devices and/or networks have been previously secured themselves. Secured communications device 200 may receive audio input 202 from a user. Audio input 202 may be, for example, voice input from the user. The secured communications device 200 encrypts the audio input 202 and outputs an encrypted audio input stream 206. The encrypted audio input stream 206 may be transmitted to a computing device to be conveyed via a communications sessions over a communications network. The device 200 may further receive an encrypted audio output stream 208 from the computing device. The encrypted audio output stream 208 may originate from a second secured communications device associated with a second user with whom the user is communicating. That is, the encrypted audio output stream 208 may be voice input from the second user. The secured communications device 200 decrypts the encrypted audio output stream 208 and outputs audio output 204 to the user via an audio output device (e.g. a speaker).

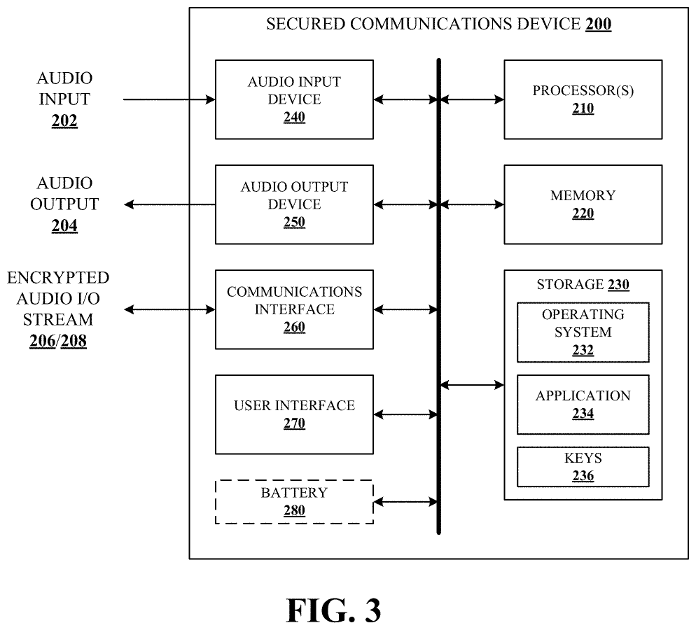

Turning now to FIG. 3, a detailed schematic block diagram of an exemplary, non-limiting embodiment of secured communications device 200 is illustrated. As shown in FIG. 2, the secured communications device 200 includes one or more processors 210 configured to execute computer-executable instructions such as instructions for an application 234 and/or an operating system 232. Such instructions may be stored on one or more computer-readable media including non-transitory, computer-readable storage media such as memory 220 and storage 230. Memory 220, in an embodiment, may include volatile storage that stores instructions, other data (working data or variables), or portions thereof during execution by processor 210. Storage 230, in an embodiment, may include non-volatile storage to persistently store an operating system 232, an application 234, a set of encryption keys 236, and/or other data or settings.

Secured communications device 200 includes an audio input device 240 (e.g. a microphone or other transducer) to accept audio input 202 such as a voice input from a user and an audio output device 250 (e.g. a speaker or the like) to play back audio output 204 such as voice input from a second user that is a party to a communication.

Secured communications device 200 can also include a communications interface 260 to communicate with a computing device (e.g. a laptop, a tablet, a mobile phone, desktop computer, etc.), such as computing devices 120 and 150 described above. In an embodiment, communications interface 260 may be a short-range wireless interface such a Bluetooth interface. To this end, the secured communications device can pair with a computing device and establish a communications link therewith in accordance with a hands-free headset profile or the like. It is to be appreciated, however, that communications interface 260 may generally be a wired or wireless interface including, but not limited, a WiFi interface, an Ethernet interface, a Bluetooth interface, a fiber optic interface, a cellular radio interface, a satellite interface, etc. Via the communications interface 260, the secured communications device 200 transmits and receives encrypted audio input/output streams 206, 208 as described above.

According to other embodiments, secured communications device 200 can include a user interface 270 and a battery 280. User interface 270 may include various buttons, switches, or other user input devices whereby a user can toggle the device 200 on/off, initiate pairing with a computing device, select an encryption key from the set of encryption keys 236, etc. For instance, an encryption key utilized for a communications session may vary depending on the parties involved, the type of communication, the type of computing devices utilized, the type of communications network, etc. Battery 280 provides a power source to enable secured communications device 200 to be a portable device readily carried by a user.

The components illustrated in FIG. 3 can integrated into a single housing. For instance, the secured communications device 200 may be implemented with a single-board computer that contains at least the processor 210, memory 220, and storage 230 and I/O pins to couple the audio input device 240, audio output device 250, communications interface 260, and/or user interface 270. The processor 210, memory 220, and/or storage 230 may be incorporated in to a system-on-a-chip (SOC) mounted to the board. The board may also incorporate the battery 280.

In accordance with an embodiment, the operating system 232 may be a Linux-based operating system, but it is to be appreciated that substantially any operating system capable of providing an interface to other software to interact with the components shown in FIG. 3 may be utilized. Application 234 includes instructions that, when executed by the processor 210, configure the processor 210 to encrypt audio input 202 received via the audio input device 240. The processor 210 may utilize an encryption key selected from the set of keys 236. The processor 210 encrypts the audio input 202 after the input passing through an analog-to-digital converter (ADC) associated with the audio input device 240.

After encryption, the processor 210 can control the communications interface 260 to transmit an encrypted audio input stream to a computing device for subsequent conveyance in a communications session. The secured communications device 200 also receives an encrypted audio output stream from the computing device via the communications interface 260. The processor 210 can decrypt the encrypted audio output stream and output the decrypted audio via the audio output device 250. In an aspect, the audio is decrypted prior to passing through a digital-to-analog converted (DAC) associated with the audio output device 250. Thus, audio is encrypted prior to leaving the secured communications device 200 and is not decrypted until playback.

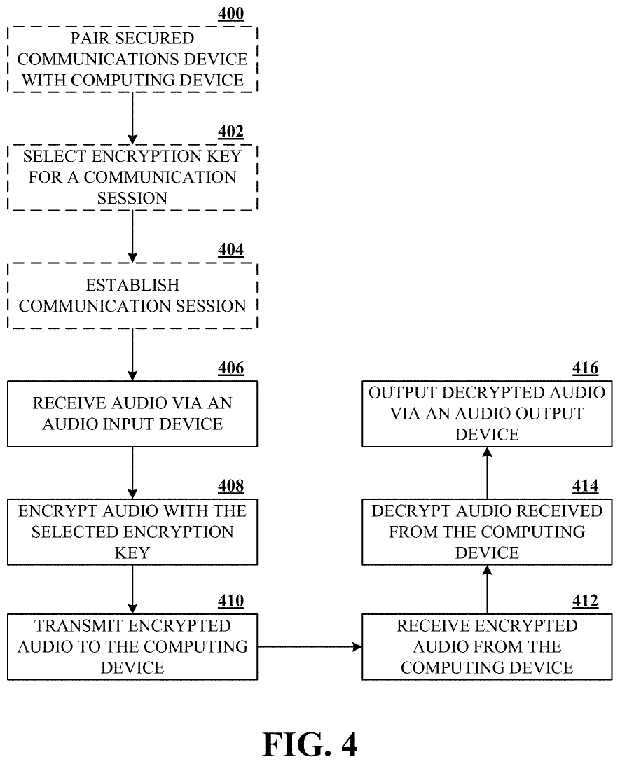

Referring now to FIG. 4, illustrated is a flow diagram of a method for providing confidential communications. The method can be implemented, for example, by secured communications device 200 described above. At 400, an optional step occurs where a secured communications device is paired with a computer device (e.g. a mobile phone or the like). Pairing may involve establishing a communications link between the secured communications device and the computing device in accordance with a headset profile and a short-range wireless protocol. At 402, an encryption key may be selected from a set of keys. The selected key may be based on an intended communication party in some embodiments. At 404, a communication session is established with a second party. The communications session may be a voice call or a VOIP call established by the computing device with a connection with a communications network (e.g. a cellular communications network, the Internet, etc.).

At 406, audio is received via an audio input device. The audio is intended to be conveyed via the communications session to the second party. At 408, the audio is encrypted with the selected encryption key. At 410, the encrypted audio is transmitted to the computing device via the communications link established via pairing. The encrypted audio may be subsequently conveyed by the computing device via the communications session. At 412, encrypted audio is received from the computing device. The received encrypted audio may be conveyed via the communications session from the second party. At 414, the encrypted audio received is decrypted and, at 416, output via an audio output device.

The embodiments above describe systems and methods for providing confidential communications via a variety of computing devices and/or communications networks. With additional innovations to the computing devices themselves, greater control and security is possible. The embodiments described below provide additional security of data communications.

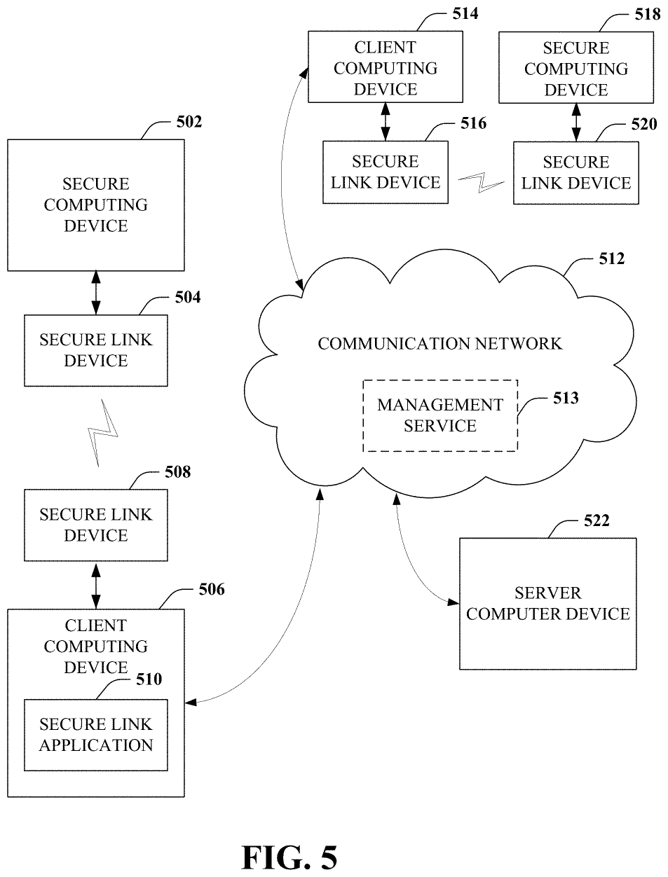

Referring now to FIG. 5 illustrates a data communications system 500 that includes a secure computing device 502 that electrically and mechanically couples and decouples with a secure link device 504. The secure computing device 502 (discussed in more detail in FIG. 2) facilitates securing and authenticating data communications by utilizing constructive key management (CKM) for data transmission and reception. In other words, the secure computing device 502 does not receive or transmit data without utilizing CKM for encryption/decryption and authentication. The secure computing device 502 can be in communication with the secure link device 504 that solely communicates with a secure link device 508 associated with a client computing device 506. The client computing device 506 can include at least a cellular connection or a Wi-Fi connection for data communications on a communication network 512. The client computing device 506 can include a secure link application 510 that enforces security protocols such as, but not limited to, locking or disabling at least one of unauthorized applications, speaker, microphone, camera, auxiliary ports, sensors, global positioning service (GPS), among others during data communications initiated by use of the secure computing device 502.

In an embodiment, such data communications from the secure computing device 502 can be implemented through the communication network 512 to at least one of an additional data communication system that includes a client computing device 514 having a secure link device 516 that is linked to a secure link device 520 that is coupled or integrated to a secure computing device 518. In an embodiment, the client computing device 514 can utilize a reader application to allow for receipt and viewing of data from the secure computing device 502 if no secure link devices are available/utilized.

In another embodiment, such data communications from the secure computing device 502 can be implemented through the communication network 512 to a server computer device 522 that is a web server or service.

The secure link device 504 is programmably linked and married to a secure link device 508 such that secure link device 504 solely transmits/receives data to/from secure link device 508.

The secure computing device 502 does not utilize a subscriber identity module (SIM) card and does not have any cellular or Wi-Fi connectivity capabilities but can communicate with data being encrypted and authenticated between the secure link device 504 and the secure link device 508 and leveraging the communication network 512 through the client computing device 506.

In an embodiment, the secure computing device 502 can include capabilities to detect cellular towers, cellular signals, or cellular devices that are unauthorized or unaffiliated with a service provider.

The system 500 protects, authenticates, and encrypts telemetry, SMS/MMS/data, VOW, SIP, applications, among others.

The secure computing device 502 can encrypt and decrypt data upon authorization for all data coming to/from the secure computing device 502.

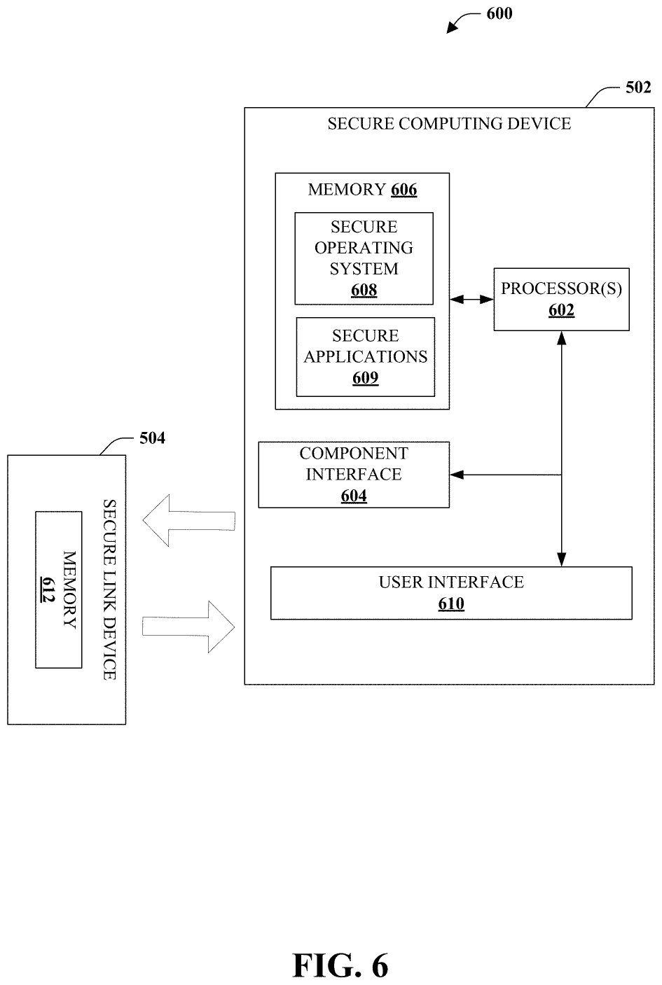

Turning to FIG. 6, a system 600 is illustrated utilizing the secure computing device 502. The secure computing device 502 includes one or more processor(s) 602 configured to execute computer-executable instructions such as instructions composing secure operating system 608 and/or secure applications 609. It is to be appreciated that one embodiment of the secure operating system is described below, but that substantially any operating system configured to provide the features described herein is contemplated. The secure applications 609 can include one or more applications that employ CKM authentication and encryption to outgoing data form the secure computing device 502, wherein the outgoing data channel is through the component interface 604 to the secure link device 604 and through Bluetooth to the secure link device 508. Such computer-executable instructions can be stored on one or more computer-readable media including a non-transitory, computer-readable storage medium such as memory 606 of secure computing device 502.

The secure computing device 502 includes a component interface 604. As shown in FIG. 6, the component interface 604 can enable electronic communications with the secure link device 504. It is to be appreciated that the component interface 604 can be a wired or wireless interface including, but not limited, a LAN cable, an Ethernet cable, a USB interface, a serial interface, a WiFi interface, a short-range RF interface (Bluetooth), an infrared interface, a near-field communication (NFC) interface, etc. It is to be appreciated that the data communication from the secure computing device 502, through the component interface 504 to the secure link device 504 will be protected, secured, and/or authenticated utilizing constructive key management (CKM), wherein CKM is a cryptographic key management and distribution process that provide role-based access control credentials and an authentication process using public-key techniques. Further, secure link device 504 will communicate via Bluetooth to secure link device 508, wherein any data communication from the secure link device 504 to the secure link device 508 will be secured and authenticated by CKM.

The secure computing device 502 can further include a user interface 610 that comprises various elements to obtain user input and to convey user output. For instance, user interface 210 can comprise a touch display which operates as both an input device and an output device. In addition, user interface 610 can also include various buttons, switches, keys, etc. by which a user can input information to secure computing device 502, and other displays, LED indicators, etc. by which other information can be output to the user.

In accordance with an embodiment, the secure computing device 502 is a computing device, which can be hosted at a physical location. However, it is to be appreciated that the secure computing device 502 can be other portable form-factors such as a laptop computer, a convertible laptop, a cell phone, a PDA, a pocket computing device, a watch computing device, a portable gaming device, a wearable computing device, or the like. Moreover, it is to be appreciated that the functionality described herein with respect to the secure computing device 502 can be performed by a desktop computer, or other larger, less portable computing device. That is, secure operating system 608 and/or secure applications 609 can be installed and executed on substantially any computing device provided that such a computing device can communicate with the secure computing device 502 as described herein.

It is to be appreciated that the secure computing device 602 can be a network or a portion of a network, wherein the network is at least one of a website, a server, a computer, a cloud-service, a processor and memory, or a computing device connected to the Internet and connected to the secure link device 504. In general, the network can be coupled to one or more devices via wired or wireless connectivity in which data communications are enabled between the network and at least one of a second network, a subnetwork of the network, or a combination thereof. It is to be appreciated that any suitable number of networks can be used with the subject innovation and data communication on networks can be selected by one of sound engineering judgment and/or one skilled in the art.

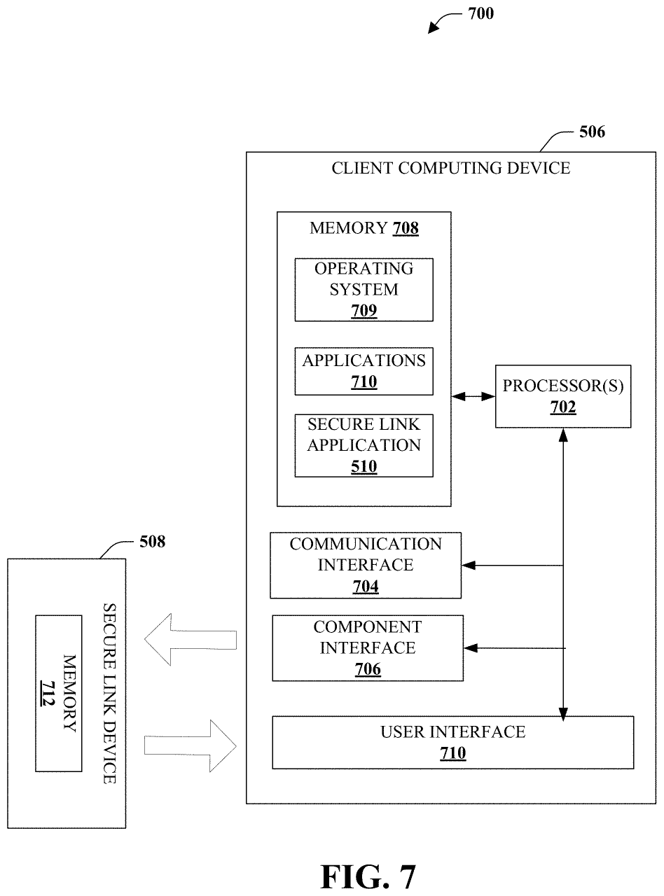

The secure link device 504 can further include a memory 612. In an embodiment, the memory 612 can be a one-block memory that is write-only and digitally assigned through programing to a companion secure link device utilized together for secure communications. In reference to FIG. 5, the secure link device 504 can include the memory 612 (shown in FIG. 6) that is digitally and programmably linked to the secure link device 508 which includes the memory 712 (shown in FIG. 7).

The secure link device 504 can be configured to releaseably couple to the component interface 604. In an embodiment, the component interface 604 can be, but is not limited to, a Universal Serial Bus (USB) connection, and in particular at least one of a USB connector, a Micro USB, a Mini USB, an 8-Pin Lighting, a USB Type-C, among others.

In still another embodiment, the secure link device 504 can be incorporated into the secure computing device 502.

Turning to FIG. 7, a system 700 is illustrated utilizing the client computing device 506. The client computing device 506 includes one or more processor(s) 702 configured to execute computer-executable instructions such as instructions composing operating system 709, applications 710, and/or secure link application 510. Such computer-executable instructions can be stored on one or more computer-readable media including a non-transitory, computer-readable storage medium such as memory 708 of client computing device 506.

The secure link application 510 can be configured to disable one or more functionalities of the client computing device 506 to eliminate risk from security breaches or other data attacks. In an embodiment, the secure link application 510 can disable data communications with or between any of a camera, auxiliary ports, microphone, speaker, sensors, global positioning service (GPS), one or more applications 710, among others.

The client computing device 506 includes a communication interface 704. As shown in FIG. 7, the communication interface 704 can enable electronic communications to and from the client computing device 506. It is to be appreciated that the communication interface 704 can be a wired or wireless interface including, but not limited, a LAN cable, an Ethernet cable, a USB interface, a serial interface, a WiFi interface, a short-range RF interface (Bluetooth), an infrared interface, a near-field communication (NFC) interface, etc.

The client computing device 506 includes a component interface 706. As shown in FIG. 7, the component interface 706 can enable electronic communications with the secure link device 508. It is to be appreciated that the component interface 706 can be a wired or wireless interface including, but not limited, a LAN cable, an Ethernet cable, a USB interface, a serial interface, a WiFi interface, a short-range RF interface (Bluetooth), an infrared interface, a near-field communication (NFC) interface, etc. It is to be appreciated that data communication through the component interface 706 from the secure link device 508 will be data that is protected, secured, and/or authenticated utilizing CKM. In an embodiment, the component interface 706 can be incorporated or integrated into the communication interface 704 and vice versa.

The client computing device 506 can further include a user interface 710 that comprises various elements to obtain user input and to convey user output. For instance, user interface 710 can comprise a touch display which operates as both an input device and an output device. In addition, user interface 710 can also include various buttons, switches, keys, etc. by which a user can input information to client computing device 506, and other displays, LED indicators, etc. by which other information can be output to the user.

In accordance with an embodiment, the client computing device 506 is a computing device, which can be hosted at a physical location. However, it is to be appreciated that the client computing device 506 can be other portable form-factors such as a laptop computer, a convertible laptop, a cell phone, a PDA, a pocket computing device, a watch computing device, a portable gaming device, a wearable computing device, or the like. Moreover, it is to be appreciated that the functionality described herein with respect to the client computing device 506 can be performed by a desktop computer, or other larger, less portable computing device. That is, operating system 709, applications 710, and/or secure link application 510 can be installed and executed on substantially any computing device provided that such a computing device can communicate with the client computing device 506 as described herein.

It is to be appreciated that the client computing device 506 can be a network or a portion of a network, wherein the network is at least one of a website, a server, a computer, a cloud-service, a processor and memory, or a computing device connected to the Internet and connected to the secure link device 508. In general, the network can be coupled to one or more devices via wired or wireless connectivity in which data communications are enabled between the network and at least one of a second network, a subnetwork of the network, or a combination thereof. It is to be appreciated that any suitable number of networks can be used with the subject innovation and data communication on networks can be selected by one of sound engineering judgment and/or one skilled in the art.

The secure link device 508 can further include a memory 712. In an embodiment, the memory 712 can be a one-block memory that is write-only and digitally assigned through programing to a companion secure link device utilized together for secure communications. In reference to FIG. 5, the secure link device 508 can include the memory 712 (shown in FIG. 7) that is digitally and programmably linked to the secure link device 104 which includes the memory 612 (shown in FIG. 6). In other words, the secure link device 504 and the secure link device 508 can be configured to transmit and receive data therebetween since they are a programmably linked and associated to one another.

The secure link device 508 can be configured to releaseably couple to the component interface 706. In an embodiment, the component interface 706 can be, but is not limited to, a Universal Serial Bus (USB) connection, and in particular at least one of a USB connector, a Micro USB, a Mini USB, an 8-Pin Lighting, a USB Type-C, among others.

In still another embodiment, the secure link device 508 can be incorporated into the client computing device 506.

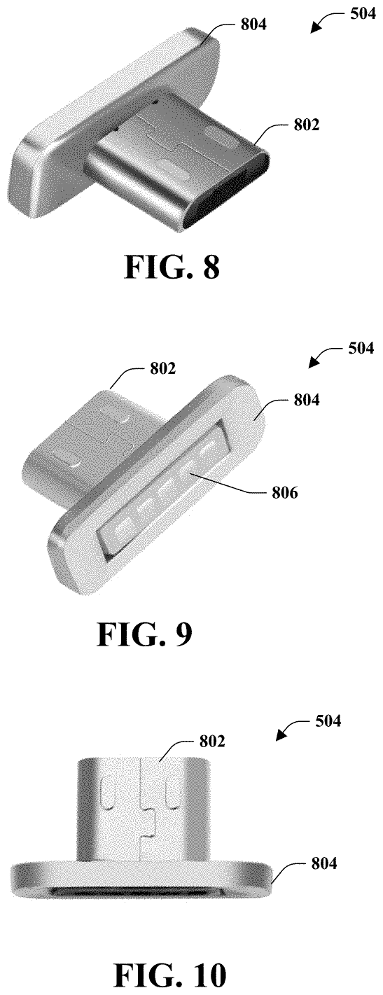

FIGS. 8-11 illustrate the secure link device 504 in a top rear perspective view, a top front perspective view, a top view, and a perspective view respectively. The secure link device 504 can include a connecting member 802 that allows connectivity to a device, wherein such connectivity can be with, for example, a component interface for the secure computing device 502 or the client computing device 506. The secure link device 504 can include a foot member 804 that is opposite the connecting member 802. The foot member 804 can be flush or have a protrusion from the secure computing device 502 (or client computing device 506) when coupled to the component interface 604 (or component interface 706 respectively). The foot member 804 can further include one or more contacts that are configured to allow electricity and/or data communications for data transmission/receipt or power.

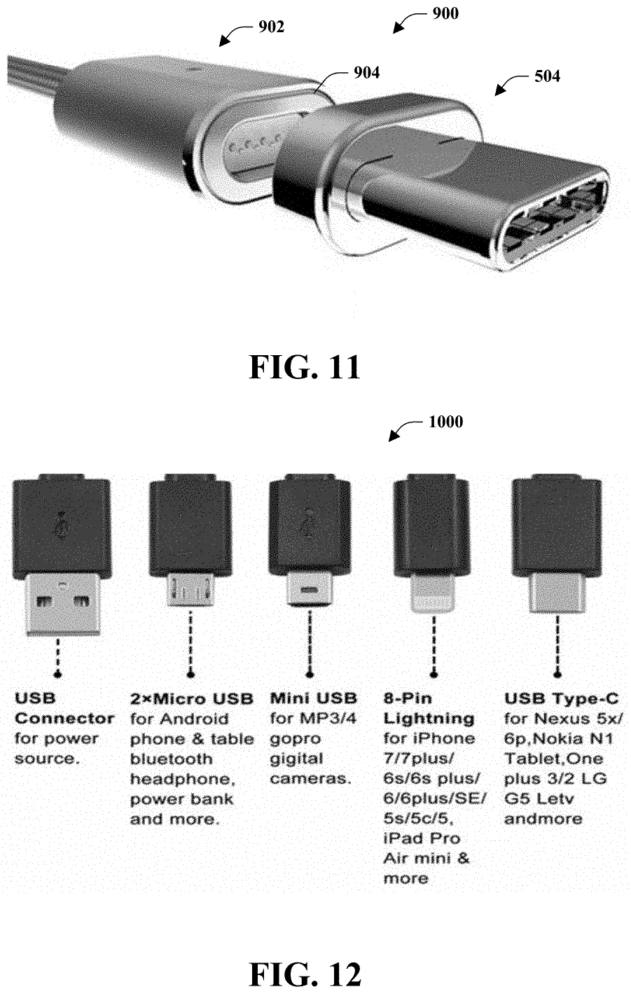

Turning to FIG. 11, the secure link device 504 is illustrated in an embodiment such that the secure link device 504 can allow a releaseably coupling of a wired connector 902 to allow for data communications and/or electrical connectivity to provide data transmission/reception or electricity. By way of example and not limitation, the wired connector 902 can provide connectivity from a power source to pass electricity through the wired connector 902 through the secure link device 504 (or the secure link device 508) through the component interface 604 (or component interface 706) to charge the secure computing device 502 (or the client computing device 506). In addition, the wired connector 902 can further provide data communications from a device through the wired connector 902 through the secure link 504 through the component interface 604 (or component interface 706) to the secure computing device 502 (or the client computing device 506). In an embodiment, the wired connector 902 releaseably couples to the secure link device 504 (or secure link device 508) with a magnetized connection with a magnet 904.

It is to be appreciated that the secure link device 504 illustrated in FIGS. 8-11 can be aesthetically similar to the secure link device 508. In particular, a programmably linked and married secure link device 504 and secure link device 508 can be substantially similar in look and feel yet the secure link device 504 will transmit data with CKM authentication and encryption and the secure link device 508 will receive such data.

FIG. 12 illustrates one or more embodiments for a component interface for electrical and mechanical connectivity between the secure link device 504 and the secure computing device 502 or the secure link device 508 and the client computing device 506. For example, the secure link device 504 can include a USC Type-C connector (e.g., male connector) that can be coupled and de-coupled to a USB Type-C port (e.g., female connector) on the secure computing device 502. In another example, the secure link device 508 can include a USC Type-C connector (e.g., male connector) that can be coupled and de-coupled to a USB Type-C port (e.g., female connector) on the client computing device 506.

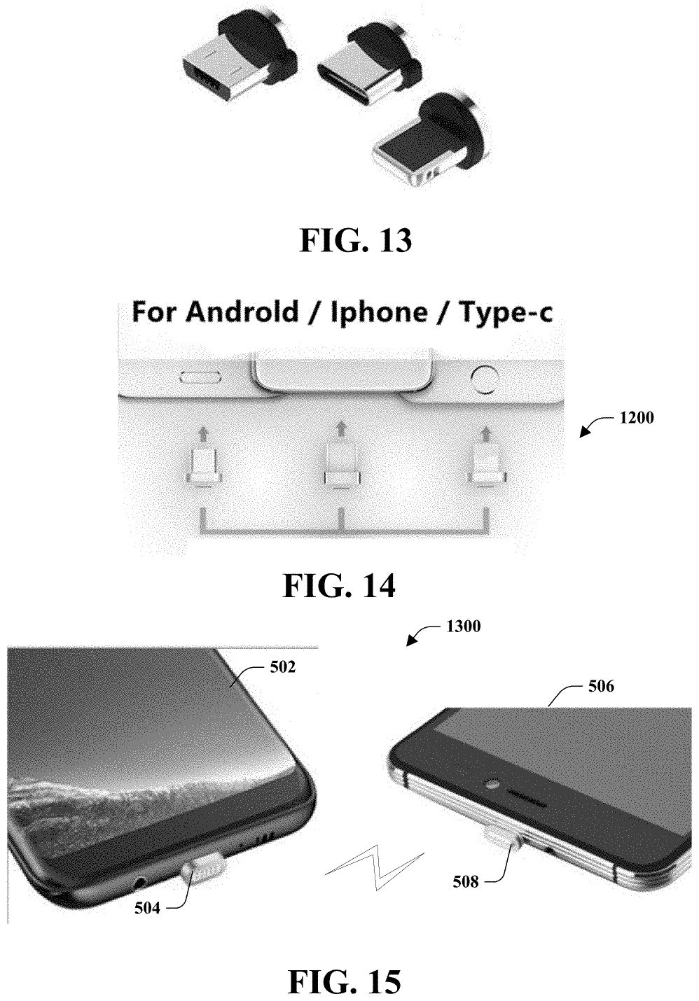

FIG. 13 illustrates embodiments of secure link devices that employ component interfaces such as, but not limited to, Micro USB, 8-Pin Lightning, and USB Type-C.

Turning to FIG. 14, connecting a secure link device to a computing device is illustrated for particular computing devices having a component interface (e.g., Android®, iPhone®, and Type-C).

FIG. 15 illustrates a system 1300 that facilitates secure data communications through the secure computing device 502 utilizing a data communications channel of the client computing device 506, wherein data transmitted from the secure computing device 502 is CKM encrypted and authenticated prior to wirelessly transmitting. It is to be appreciated that the data encrypted and authenticated by CKM is wirelessly transmitted via Bluetooth from the secure link device 504 to the secure link device 508.

Secure Link

Secure Link is a revolutionary device that works with any smartphone and connect to it externally via a provided hardware interface. As a separate external device, with no networking or Bluetooth capabilities, it offers complete protection for the connected smartphone affording the quantum-safe protection of telemetry/VOIP/SIP and SMS/MMS/Data communication, as well as being able to verify proprietary signed and unsigned installed applications. Being connected through a hardware interface ensures that no remote interference can compromise any part of the communication process.

The external device can ensure that nothing can sync to the device that is not protected with a Constructive Key Management solution and utilizes at least two secure applications be installed on the smartphone being protected that is capable of authenticating the user and decoding the protected data. In scenarios where the communications receiver does not have the Secure Link device, there is be a ‘reader’ app that affords Constructive Key Management technology to the device to allow the receiver to view the data.

The Secure Link system includes a Secure Link Computing Device, may be a cellphone without the ability to connect to a provider service. There is no ability for the device to make a call, send a text, transmit a file, or have a video call without another hardware device having an outside connection (e.g. Wifi, cell service or Bluetooth.). The Secure Link Computing Device does not allow any type of communication to or from the device without other media.

The Secure Link system also includes a secured operating system (OS) for the Secure Link Computing Device. The Secured OS may based on the Android OS. In particular, the Secured OS is a stripped down version of Android that is modified for the purposes of Secure Link. For instance, a base Android OS is stripped of all apps not usable on the Secure Link Computing Device. For example, there are no social media applications or recreational applications. Further, some standard OEM apps such as a calculator or flashlight may also collect data and/or send data to respective developers or providers. Thus, these apps are also removed. The Secured OS is protected by CKM. No updates to the OS occur unless the files are authenticated. Authorized files from Secure Link are also protected by CKM. The OS and device cannot accept a file that is not CKM protected.

The system also includes a Secure Link Communication Device. As described above, the Secure Link Computing Device does not have any outside connections. To be able to communicate with the Secure Link Computing Device, the Secure Link Communication Device is used. The device is installed on the Secure Link Computing Device and a Client Computing Device that has communication connections to the outside world. All transmissions are secured at the Secure Link Computing Device prior to being sent to the Client Computing Device for delivery. Each device may be protected with CFM to only allow authenticated CKM packets to be received. This ensures that no rogue software can compromise the chipset and device OS/Kernal. The Secure Link Communcation Device may have various fitting for different devices. The Secure Link side may be a permenant piece.

The system also includes secure applications. Both devices (e.g. the Secure Link Computing Device and the Client Computing Device) include applications that communicate in the secure enclave of Secure link. The applications ensure that all data leaving and received by the Secure Link Computing Device is protected with quantum safe technologies that cannot be compromised on the client computing device.

A first application is software that allows the communication between the Client computing device and the Secured Micro Connector or Secure Link Communication Device. This contains the libraries and binaries essential to running CKM solution for protecting data. This application ensures many security situations. In an embodiment, the secure device the app is protected by CKM. This allows only authenticated and authorized data to be sent through the secure micro connector to the customers connection device, where it will be accepted through the secure micro connector on the client end (being an authenticated and authorized CKM data transmission) and accepted by the second application on the client device. The client connection send the data to Secure Link servers for delivery. The transmission to the servers ensures the confidentiality of all communications. This transmission allows the users to be completely anonymous with even having a fake email. This application may also, at the time of communication, block the client device speaker, camera, microphone, and contain in a secure enclave any communications from apps or other means within the client device.

A second application is installed on the Secure Link Computing Device and is configured for receiving the data protected with the CKM solution, authenticating the data, and decoding the data. No unauthorized file can be loaded to the secure device. The second application protects the device from any third party compromises. No applications will be on the Secure Link Computing device that are not controlled by Secure Link. Each application may be married to each secure micro connector, and each secure micro connector may be married to each other. Accordingly, no other secure micro connectors can interfere with your secure micro if in the same vicinity.

The Secure Link external device (the Secure Link Computing Device) is a stripped-down version of an Android smartphone. It does not have any networking and Bluetooth adapters are removed completely, implying that it also does not have any SIM-based capabilities either. Thus, the device: does not connect with any SIM-based provider; communicates with the_smartphone via hardware interface; communications only with CKM protected packets; and, when connected, performs all functionality through Secure Link.

Additional services or applications enables with Secure Link include, for example, applications and/or services for secure wallets, secure video communication, secure audio communication, secure two-factor authentication, secure login for programs and website, secure messaging, secure voted identification, and prevention of identity theft.

Secure Link is a type of device that will have no competitor because of the ability of the special proprietary CKM solution, protected by various patents. It can ensure that nothing can sync to the device that is not protected with the CKM solution and secure applications installed on the smartphone being protected that is capable of authenticating the user and decoding protected data. In scenarios where the communications receiver does not have a Secure Link device, a ‘reader’ application can afford CKM technology to the communications receiver device to allow them to view the data.

In another embodiment, the client computing device can be removed. Here, the secure link computing device allows outside communication. For instance, the secure link computing device may physically separate the communications interface from the other components of the device. The main processing components of the device may couple to the communications interface in a similar fashion as the secure link computing device and the client computing device link as described above. For example, integrated connector-like components can be utilized within a common housing of a secure link computing device to bridge the main processing components with the communications interface.

Secure Link Micro Connector

The Secure Link Computing Device is a mobile device in which the use of all of its wireless connection protocols are removed from the hardware and/or programmatically. Although creating such a device seems contrary to maintaining a connected and communicating world, it is but a single piece of the Secure Link solution. In order to allow secure communication with known protocols, Secure Link provides a secure transmitter and a receiver device, called “secure transmitter”, that can interface with the mobile device via a micro USB controller.

Each micro USB controller connection will have a unique identifier that marries or locks the other device (e.g. another micro USB controller device) to the micro USB controller device. These controllers have a ‘single-write’ block of memory so that when it is ‘married’, it will not work with any other connector, such that the controller itself cannot be compromised.

The micro USB controller device mitigates the security vulnerabilities of using vulnerable embedded connections that come with smartphones and ultimately facilitates developing an entirely secure smartphone in of itself.

The micro USB controller prevents uploads to the Secure Link computing device that are not authorized and may be malicious. The Secure Link computing device itself will have no wireless communication capabilities such that it cannot be compromised. Using another technology, constructive key management (CKM), the micro USB controller prevents unauthorized files from uploading to the device.

The Secure Link Computing Device has all of its wireless protocols removed either by hardware or programmatically, or by both means. The Secure Link Computing Device includes a USB connection. This device is ‘married’ to a single secure transmitter device through which it only allows wired communication with the authenticated and ‘married’ device. Communicated information will be protected with the CKM solution.

The Secure Transmitter Device allows wireless facing capabilities, secures them, and communicates the secured information to the Secure Link Computing Device. This device is ‘married’ to a single secure Link computing device in which it only allows wired communication with the authenticated and ‘married’ device. Communicated information is protected with the CKM solution. The Secured Micro Connectors (secure transmitter devices) are programmable. The Secured Micro Connector includes a memory that is a “Once Write” memory. This allows the Secure Micro Connector to “marry” another Secured Micro Connector so that they can only deliver and receive data from/to each other. No other Secured Micro Connectors can work once Married. Locking to the client computing device may not needed since that secured micro connector is married to the secure link computing device. Accordingly, in an aspect, the secured micro connector for the client computing device can be used on any smart phone available. With CKM or Veil, any transfer of data to the secure link computing device through the secured micro connector on the secure link computing device side can only accept file uploads (that have exe code) that are direct from a trusted party (e.g. the manufacturer of the secure link system). If the client loses the Secured Micro Connector on the client computing phone side, a new pair of Secured Micro Connectors can be issued to the client so that the clients Secure Link will continue to work. Once these Secured Micro Controllers are installed, they will marry to each other as well as described above. Each Secured Micro Controller on both sides will have an application on the associated computing device.

Secure Link Operating System

The Secure Link Operating System (OS), in an embodiment, is a stripped down version of normal OEM android operating systems. For the purposes of the Secure Link Device, limited OS functionality is maintained, which further assists to secure the OS to levels keep the device secure. All OEM applications are removed. The only applications remaining are ones that created for added functionality of the secure link device.

The applications that may be part of the Secure Link OS include, for example: an SMS application, a quantum SMS application (e.g. Incrypt, nerve, vme), a voice call application, a secure file storage application, a camera application, a gallery application, an email application, a wallet application, a web browser, a clock application, a contacts application, a voice recorder application, and other applications that may be developed.

As noted above, all connections to recipients will go through a seperate device that a user utilizes as their communications device. The Secure Link Device will have no ability to communicate other than to the client computing device to be delivered.

In an embodiment, at the operating system level, the Android platform provides the security of the Linux kernel, as well as a secure inter-process communication (IPC) facility to enable secure communication between applications running in different processes. These security features at the OS level ensure that even native code is constrained by the Application Sandbox. Whether that code is the result of included application behavior or an exploitation of an application vulnerability, the system is designed to prevent the rogue application from harming other applications, the Android system, or the device itself.

The foundation of the Android platform is the Linux kernel. The Linux kernel has been in widespread use, and is used in many security-sensitive environments. Through its history of constantly being researched, attacked, and fixed by thousands of developers, Linux has become a stable and secure kernel trusted by many corporations and security professionals. As the base for a mobile computing environment, the Linux kernel provides Android with several key security features, including a user-based permissions model, process isolation, extensible mechanism for secure IPC, and the ability to remove unnecessary and potentially insecure portions of the kernel. As a multiuser operating system, a fundamental security objective of the Linux kernel is to isolate user resources from one another. The Linux security philosophy is to protect user resources from one another. Thus, Linux prevents user A from reading user B's files, ensures that user A does not exhaust user B's memory, ensures that user A does not exhaust user B's CPU resources, and/or ensures that user A does not exhaust user B's devices (for example, telephony, GPS, and Bluetooth).

Application security may be enforced by the application sandbox, which isolates applications from each other and isolates the system from malicious applications. A system partition contains the kernel as well as operating system libraries, application runtime, application framework, and applications. This partition is read-only. When a user boots the device into Safe Mode, third-party applications may be launched manually by the device owner but are not launched by default. In a UNIX-style environment, file system permissions ensure that one user cannot alter or read another user's files. In the case of Android, each application runs as its own user. Unless the developer explicitly shares files with other applications, files created by one application cannot be read or altered by another application. In addition, Android uses Security-Enhanced Linux (SELinux) to apply access control policies and establish mandatory access control (mac) on processes.

Android 6.0 and later supports verified boot and device-mapper-verity. Verified boot guarantees the integrity of the device software starting from a hardware root of trust up to the system partition. During boot, each stage cryptographically verifies the integrity and authenticity of the next stage before executing it. Android 7.0 and later supports strictly enforced verified boot, which means compromised devices cannot boot.

Android provides a set of cryptographic APIs for use by applications. These include implementations of standard and commonly used cryptographic primitives such as AES, RSA, DSA, and SHA. Additionally, APIs are provided for higher level protocols such as SSL and HTTPS. Android 4.0 introduced the KeyChain class to allow applications to use the system credential storage for private keys and certificate chains.

By default, on Android only the kernel and a small subset of the core applications run with root permissions. Android does not prevent a user or application with root permissions from modifying the operating system, kernel, or any other application. In general, root has full access to all applications and all application data. Users that change the permissions on an Android device to grant root access to applications increase the security exposure to malicious applications and potential application flaws.

The ability to modify an Android device they own is important to developers working with the Android platform. On many Android devices users have the ability to unlock the bootloader in order to allow installation of an alternate operating system. These alternate operating systems may allow an owner to gain root access for purposes of debugging applications and system components or to access features not presented to applications by Android APIs.

On some devices, a person with physical control of a device and a USB cable is able to install a new operating system that provides root privileges to the user. To protect any existing user data from compromise the bootloader unlock mechanism requires that the bootloader erase any existing user data as part of the unlock step. Root access gained via exploiting a kernel bug or security hole can bypass this protection.

Encrypting data with a key stored on-device does not protect the application data from root users. Applications can add a layer of data protection using encryption with a key stored off-device, such as on a server or a user password. This approach can provide temporary protection while the key is not present, but at some point the key must be provided to the application and it then becomes accessible to root users.

A more robust approach to protecting data from root users is through the use of hardware solutions. OEMs may choose to implement hardware solutions that limit access to specific types of content such as DRM for video playback, or the NFC-related trusted storage for Google wallet.

In the case of a lost or stolen device, full filesystem encryption on Android devices uses the device password to protect the encryption key, so modifying the bootloader or operating system is not sufficient to access user data without the user's device password.

Android 3.0 and later provides full filesystem encryption, so all user data can be encrypted in the kernel. Android 5.0 and later supports full-disk encryption. Full-disk encryption uses a single key—protected with the user's device password—to protect the whole of a device's user data partition. Upon boot, users must provide their credentials before any part of the disk is accessible. Android 7.0 and later supports file-based encryption. File-based encryption allows different files to be encrypted with different keys that can be unlocked independently. Android can be configured to verify a user-supplied password prior to providing access to a device. In addition to preventing unauthorized use of the device, this password protects the cryptographic key for full filesystem encryption. Use of a password and/or password complexity rules can be required by a device administrator.

Android 2.2 and later provide the Android Device Administration API, which provides device administration features at the system level. For example, the built-in Android Email application uses the APIs to improve Exchange support. Through the Email application, Exchange administrators can enforce password policies—including alphanumeric passwords or numeric PINs—across devices. Administrators can also remotely wipe (that is, restore factory defaults on) lost or stolen handsets. In addition to use in applications included with the Android system, these APIs are available to third-party providers of Device Management solutions.

Android provides an open source platform and application environment for mobile devices. The core operating system is based on the Linux kernel. Android applications are most often written in the Java programming language and run in the Dalvik virtual machine. However, applications can also be written in native code. Applications are installed from a single file with the .apk file extension.

The main building application building blocks include:

AndroidManifest.xml: The AndroidManifest.xml file is the control file that tells the system what to do with all the top-level components (specifically activities, services, broadcast receivers, and content providers described below) in an application. This also specifies which permissions are required.

Activities: An Activity is, generally, the code for a single, user-focused task. It usually includes displaying a UI to the user, but it does not have to—some Activities never display UIs. Typically, one of the application's Activities is the entry point to an application.

Services: A Service is a body of code that runs in the background. It can run in its own process, or in the context of another application's process. Other components “bind” to a Service and invoke methods on it via remote procedure calls. An example of a Service is a media player: even when the user quits the media-selection UI, the user probably still intends for music to keep playing. A Service keeps the music going even when the UI has completed.

Broadcast Receiver: A BroadcastReceiver is an object that is instantiated when an IPC mechanism known as an Intent is issued by the operating system or another application. An application may register a receiver for the low battery message, for example, and change its behavior based on that information.

All applications on Android run in an Application Sandbox. By default, an Android application can only access a limited range of system resources. The system manages Android application access to resources that, if used incorrectly or maliciously, could adversely impact the user experience, the network, or data on the device.

These restrictions are implemented in a variety of different forms. Some capabilities are restricted by an intentional lack of APIs to the sensitive functionality (e.g. there is no Android API for directly manipulating the SIM card). In some instances, separation of roles provides a security measure, as with the per-application isolation of storage. In other instances, the sensitive APIs are intended for use by trusted applications and protected through a security mechanism known as Permissions.

The protected APIs include, for example, camera functions, location data (GPS), Bluetooth functions, telephony functions, SMS/MMS functions, and network/data connections.

These resources are only accessible through the operating system. To make use of the protected APIs on the device, an application must define the capabilities it needs in its manifest. All Android versions 6.0 and higher use a runtime permissions model. If a user requests a feature from an app that requires a protected API the system displays a dialog, prompting the user to deny or allow the permission.

Once granted, the permissions are applied to the application as long as it is installed. To avoid user confusion, the system does not notify the user again of the permissions granted to the application, and applications that are included in the core operating system or bundled by an OEM do not request permissions from the user. Permissions are removed if an application is uninstalled, so a subsequent re-installation will again result in display of permissions.

Within the device settings, users are able to view permissions for applications they have previously installed. Users can also turn off some functionality globally when they choose, such as disabling GPS, radio, or wi-fi.

In the event that an application attempts to use a protected feature which has not been declared in the application's manifest, the permission failure will typically result in a security exception being thrown back to the application. Protected API permission checks are enforced at the lowest possible level to prevent circumvention.

The system has default permissions. Applications may declare their own permissions for other applications to use. Such permissions are not listed in the above location. When defining a permission a protectionLevel attribute tells the system how the user is to be informed of applications requiring the permission, or who is allowed to hold a permission. There are some device capabilities, such as the ability to send SMS broadcast intents, that are not available to third-party applications, but that may be used by applications pre-installed by the OEM. These permissions use the signatureOrSystem permission.

Android strives to make it clear to users when they are interacting with third-party applications and inform the user of the capabilities those applications have. Prior to installation of any application, the user is shown a clear message about the different permissions the application is requesting. After install, the user is not prompted again to confirm any permissions.

There are many reasons to show permissions immediately prior to installation time. This is when user is actively reviewing information about the application, developer, and functionality to determine whether it matches their needs and expectations. It is also important that they have not yet established a mental or financial commitment to the app, and can easily compare the application to other alternative applications.

Some other platforms use a different approach to user notification, requesting permission at the start of each session or while applications are in use. The vision of Android is to have users switching seamlessly between applications at will. Providing confirmations each time would slow down the user and prevent Android from delivering a great user experience. Having the user review permissions at install time gives the user the option to not install the application if they feel uncomfortable.

Also, many user interface studies have shown that over-prompting the user causes the user to start saying “OK” to any dialog that is shown. One of Android's security goals is to effectively convey important security information to the user, which cannot be done using dialogs that the user will be trained to ignore. By presenting the important information once, and only when it is important, the user is more likely to think about what they are agreeing to.

Some platforms choose not to show any information at all about application functionality. That approach prevents users from easily understanding and discussing application capabilities. While it is not possible for all users to always make fully informed decisions, the Android permissions model makes information about applications easily accessible to a wide range of users. For example, unexpected permissions requests can prompt more sophisticated users to ask critical questions about application functionality and share their concerns in places such as Google Play where they are visible to all users.

Processes can communicate using any of the traditional UNIX-type mechanisms. Examples include the filesystem, local sockets, or signals. However, the Linux permissions still apply.

Android also provides new IPC mechanisms:

Binder: A lightweight capability-based remote procedure call mechanism designed for high performance when performing in-process and cross-process calls. Binder is implemented using a custom Linux driver.

Services: Services (discussed above) can provide interfaces directly accessible using binder.

Intents: An Intent is a simple message object that represents an “intention” to do something. For example, if your application wants to display a web page, it expresses its “Intent” to view the URL by creating an Intent instance and handing it off to the system. The system locates some other piece of code (in this case, the Browser) that knows how to handle that Intent, and runs it. Intents can also be used to broadcast interesting events (such as a notification) system-wide.

ContentProviders: A ContentProvider is a data storehouse that provides access to data on the device; the classic example is the ContentProvider that is used to access the user's list of contacts. An application can access data that other applications have exposed via a ContentProvider, and an application can also define its own ContentProviders to expose data of its own.

While it is possible to implement IPC using other mechanisms such as network sockets or world-writable files, these are the recommended Android IPC frameworks. Android developers will be encouraged to use best practices around securing users' data and avoiding the introduction of security vulnerabilities.

A cost sensitive API is any function that might generate a cost for the user or the network. The Android platform has placed cost sensitive APIs in the list of protected APIs controlled by the OS. The user will have to grant explicit permission to third-party applications requesting use of cost sensitive APIs. These APIs include telephony, SMS/MMS, Network/Data, In-App Billing, and NFC access. Android 4.2 adds further control on the use of SMS. Android will provide a notification if an application attempts to send SMS to a short code that uses premium services which might cause additional charges. The user can choose whether to allow the application to send the message or block it.

Low level access to the SIM card is not available to third-party apps. The OS handles all communications with the SIM card including access to personal information (contacts) on the SIM card memory. Applications also cannot access AT commands, as these are managed exclusively by the Radio Interface Layer (RIL). The RIL provides no high level APIs for these commands.

Android has placed APIs that provide access to user data into the set of protected APIs. With normal usage, Android devices will also accumulate user data within third-party applications installed by users. Applications that choose to share this information can use Android OS permission checks to protect the data from third-party applications.

System content providers that are likely to contain personal or personally identifiable information such as contacts and calendar have been created with clearly identified permissions. This granularity provides the user with clear indication of the types of information that may be provided to the application. During installation, a third-party application may request permission to access these resources. If permission is granted, the application can be installed and will have access to the data requested at any time when it is installed.

Any applications which collect personal information will, by default, have that data restricted only to the specific application. If an application chooses to make the data available to other applications though IPC, the application granting access can apply permissions to the IPC mechanism that are enforced by the operating system.

Android devices frequently provide sensitive data input devices that allow applications to interact with the surrounding environment, such as camera, microphone or GPS. For a third-party application to access these devices, it must first be explicitly provided access by the user through the use of Android OS Permissions. Upon installation, the installer will prompt the user requesting permission to the sensor by name.

If an application wants to know the user's location, the application requires a permission to access the user's location. Upon installation, the installer will prompt the user asking if the application can access the user's location. At any time, if the user does not want any application to access their location, then the user can run the “Settings” application, go to “Location & Security”, and uncheck the “Use wireless networks” and “Enable GPS satellites”. This will disable location based services for all applications on the user's device.

Android also strives to restrict access to data that is not intrinsically sensitive, but may indirectly reveal characteristics about the user, user preferences, and the manner in which they use a device. By default applications do not have access to operating system logs, browser history, phone number, or hardware/network identification information. If an application requests access to this information at install time, the installer will prompt the user asking if the application can access the information. If the user does not grant access, the application will not be installed.

Android includes a set of installed system Certificate Authorities, which are trusted system-wide. Prior to Android 7.0, device manufacturers could modify the set of CAs shipped on their devices. However, devices running 7.0 and above will have a uniform set of system CAs as modification by device manufacturers is no longer permitted. To be added as a new public CA to the Android stock set, the CA must complete the Mozilla CA Inclusion Process and then file a feature request against Android to have the CA added to the stock Android CA set in the Android Open Source Project (AOSP).

There are still CAs that are device-specific and should not be included in the core set of AOSP CAs, like carriers' private CAs that may be needed to securely access components of the carrier's infrastructure, such as SMS/MMS gateways. Device manufacturers are encouraged to include the private CAs only in the components/apps that need to trust these CAs.

Code signing allows developers to identify the author of the application and to update their application without creating complicated interfaces and permissions. Every application that is run on the Android platform must be signed by the developer. Applications that attempt to install without being signed are rejected by either Google Play or the package installer on the Android device.

On Google Play, application signing bridges the trust Google has with the developer and the trust the developer has with their application. Developers know their application is provided, unmodified to the Android device; and developers can be held accountable for behavior of their application.

On Android, application signing is the first step to placing an application in its Application Sandbox. The signed application certificate defines which user id is associated with which application; different applications run under different user IDs. Application signing ensures that one application cannot access any other application except through well-defined IPC.

When an application (APK file) is installed onto an Android device, the Package Manager verifies that the APK has been properly signed with the certificate included in that APK. If the certificate (or, more accurately, the public key in the certificate) matches the key used to sign any other APK on the device, the new APK has the option to specify in the manifest that it will share a UID with the other similarly-signed APKs.

Applications can be signed by a third-party (OEM, operator, alternative market) or self-signed. Android provides code signing using self-signed certificates that developers can generate without external assistance or permission. Applications do not have to be signed by a central authority. Android currently does not perform CA verification for application certificates.

Applications are also able to declare security permissions at the Signature protection level, restricting access only to applications signed with the same key while maintaining distinct UIDs and Application Sandboxes. A closer relationship with a shared Application Sandbox is allowed via the shared UID feature where two or more applications signed with same developer key can declare a shared UID in their manifest.

Android 4.2 and later support application verification. Users can choose to enable “Verify Apps” and have applications evaluated by an application verifier prior to installation. App verification can alert the user if they try to install an app that might be harmful; if an application is especially bad, it can block installation.

The Android platform provides an extensible DRM framework that lets applications manage rights-protected content according to the license constraints that are associated with the content. The DRM framework supports many DRM schemes; which DRM schemes a device supports is left to the device manufacturer.

The Android DRM framework is implemented in two architectural layers: a DRM framework API, which is exposed to applications through the Android application framework and runs through the Dalvik VM for standard applications; and a native code DRM manager, which implements the DRM framework and exposes an interface for DRM plug-ins (agents) to handle rights management and decryption for various DRM schemes.

The Android Security Team regularly receives requests for information about preventing potential security issues on Android devices. We also occasionally spot check devices and let device manufacturers and affected partners know of potential issues. To facilitate adoption of these best practices, where possible the Android Security Team incorporates tests into the Android Compatibility Test Suite (CTS) and Android Lint.

Source code review can detect a broad range of security issues, including those identified in this document. Android strongly encourages both manual and automated source code review. Best practices include: run Android Lint on all application code using the Android SDK and correct any identified issues; native code should be analyzed using an automated tool that can detect memory management issues such as buffer overflows and off-by-one errors; and the Android build system has support for many of the LLVM sanitizers, such as AddressSanitizer and UndefinedBehaviorSanitizer which can be used for this purpose.

Automated testing can detect a broad range of security issues, including several issues discussed below. Best practices include: CTS is regularly updated with security tests; run the most recent version of CTS to verify compatibility; run CTS regularly throughout the development process to detect problems early and reduce time to correction. Android uses CTS as part of continuous integration in our automated build process, which builds multiple times per day; and device manufacturers should automate security testing of interfaces, including testing with malformed inputs (fuzz testing).

The signature of the system image is critical for determining the integrity of the device. Best practices include: devices must not be signed with a key that is publicly known; and keys used to sign devices should be managed in a manner consistent with industry standard practices for handling sensitive keys, including a hardware security module (HSM) that provides limited, auditable access.

Application signatures play an important role in device security and are used for permissions checks as well as software updates. When selecting a key to use for signing applications, it is important to consider whether an application will be available only on a single device or common across multiple devices. Best practices include: applications must not be signed with a key that is publicly known; keys used to sign applications should be managed in a manner consistent with industry standard practices for handling sensitive keys, including an HSM that provides limited, auditable access; applications should not be signed with the platform key; and applications with the same package name should not be signed with different keys. This often occurs when creating an application for different devices, especially when using the platform key. If the application is device-independent, use the same key across devices. If the application is device-specific, create unique package names per device and key.

Google Play provides device manufacturers the ability to update applications without performing a complete system update. This can expedite response to security issues and delivery of new features, as well as provide a way to ensure your application has a unique package name. Best practices include: upload your applications to Google Play to allow automated updates without requiring a full over-the-air (OTA) update. Applications that are uploaded but unpublished are not directly downloadable by users but the applications are still updated. Users who have previously installed the app can re-install it and/or install on other devices. Create an application package name that is clearly associated with your company, such as by using a company trademark. Applications published by device manufacturers should be uploaded on the Google Play store to avoid package name impersonation by third-party users. If a device manufacturer installs an app on a device without publishing the app on the Play store, another developer could upload the same app, use the same package name, and change the metadata for the app. When the app is presented to the user, this unrelated metadata could create confusion.

External parties must have the ability to contact device manufacturers about device-specific security issues. We recommend creating a publicly accessible email address for managing security incidents. Create a security@your-company.com or similar address and publicize it. If you become aware of a security issue affecting Android OS or Android devices from multiple device manufacturers, you should contact the Android Security Team by filing a Security bug report.

Root processes are the most frequent target of privilege escalation attacks, so reducing the number of root processes reduces risk of privilege escalation. CTS includes an informational test that lists root processes. Devices should run the minimum necessary code as root. Where possible, use a regular Android process rather than a root process. The ICS Galaxy Nexus has only six root processes: vold, inetd, zygote, tf daemon, ueventd, and init. If a process must run as root on a device, document the process in an AOSP feature request so it can be publicly reviewed. Where possible, root code should be isolated from untrusted data and accessed via IPC. For example, reduce root functionality to a small Service accessible via Binder and expose the Service with signature permission to an application with low or no privileges to handle network traffic. Root processes must not listen on a network socket. Root processes must not provide a general-purpose runtime for applications (for example, a Java VM).

In general, pre-installed apps should not run with the shared system UID. If is it necessary, however, for an app to use the shared UID of system or another privileged service (i.e., phone), the app should not export any services, broadcast receivers, or content providers that can be accessed by third-party apps installed by users. Devices should run the minimum necessary code as system. Where possible, use an Android process with its own UID rather than reusing the system UID. Where possible, system code should be isolated from untrusted data and expose IPC only to other trusted processes. System processes must not listen on a network socket.

The Android Application Sandbox provides applications with an expectation of isolation from other processes on the system, including root processes and debuggers. Unless debugging is specifically enabled by the application and the user, no application should violate that expectation. Root processes must not access data within individual application data folders, unless using a documented Android debugging method. Root processes must not access memory of applications, unless using a documented Android debugging method. Devices must not include any application that accesses data or memory of other applications or processes.

New setuid programs should not be accessible by untrusted programs. Setuid programs have frequently been the location of vulnerabilities that can be used to gain root access, so strive to minimize the availability of the setuid program to untrusted applications. SUID processes must not provide a shell or backdoor that can be used to circumvent the Android security model. SUID programs must not be writable by any user. SUID programs should not be world readable or executable. Create a group, limit access to the SUID binary to members of that group, and place any applications that should be able to execute the SUID program into that group. SUID programs are a common source of user rooting of devices. To reduce this risk, SUID programs should not be executable by the shell user. CTS verifier includes an informational test listing SUID files; some setuid files are not permitted per CTS tests.

CTS tests fail when a device is listening on any port, on any interface. In the event of a failure, Android verifies the following best practices. There should be no listening ports on the device. Listening ports must be able to be disabled without an OTA. This can be either a server or user-device configuration change. Root processes must not listen on any port. Processes owned by the system UID must not listen on any port. For local IPC using sockets, applications must use a UNIX Domain Socket with access limited to a group. Create a file descriptor for the IPC and make it +RW for a specific UNIX group. Any client applications must be within that UNIX group. Some devices with multiple processors (e.g. a radio/modem separate from the application processor) use network sockets to communicate between processors. In such instances, the network socket used for inter-processor communication must use an isolated network interface to prevent access by unauthorized applications on the device (that is, use iptables to prevent access by other applications on the device). Daemons that handle listening ports must be robust against malformed data. Google may conduct fuzz-testing against the port using an unauthorized client, and, where possible, authorized client. Any crashes will be filed as bugs with an appropriate severity.

Logging data increases the risk of exposure of that data and reduces system performance. Multiple public security incidents have occurred as the result of logging sensitive user data by applications installed by default on Android devices. Applications or system services should not log data provided from third-party applications that might include sensitive information. Applications must not log any Personally Identifiable Information (PII) as part of normal operation. CTS includes tests that check for the presence of potentially sensitive information in the system logs.

World-writable directories can introduce security weaknesses and enable an application to rename trusted files, substitute files, or conduct symlink-based attacks (attackers may use a symlink to a file to trick a trusted program into performing actions it shouldn't). Writable directories can also prevent the uninstall of an application from properly cleaning up all files associated with an application. As a best practice, directories created by the system or root users should not be world writable. CTS tests help enforce this best practice by testing known directories.

Many drivers and services rely on configuration and data files stored in directories such as /system/etc and/data. If these files are processed by a privileged process and are world writable, it is possible for an app to exploit a vulnerability in the process by crafting malicious contents in the world-writable file. Configuration files used by privileged processes should not be world readable. Configuration files used by privileged processes must not be world writable.

Any code used by privileged device manufacturer processes must be in /vendor or/system; these filesystems are mounted read-only on boot. As a best practice, libraries used by system or other highly-privileged apps installed on the phone should also be in these filesystems. This can prevent a security vulnerability that could allow an attacker to control the code that a privileged process executes.

Only trusted code should have direct access to drivers. Where possible, the preferred architecture is to provide a single-purpose daemon that proxies calls to the driver and restricts driver access to that daemon. As a best practice, driver device nodes should not be world readable or writable. CTS tests help enforce this best practice by checking for known instances of exposed drivers.

Android debug bridge (adb) is a valuable development and debugging tool, but is designed for use in controlled, secure environments and should not be enabled for general use. ADB must be disabled by default. ADB must require the user to turn it on before accepting connections.

Many Android devices support unlocking, enabling the device owner to modify the system partition and/or install a custom operating system. Common use cases include installing a third-party ROM and performing systems-level development on the device. As a best practice, unlockable Android devices must securely erase all user data prior to being unlocked. Failure to properly delete all data on unlocking may allow a physically proximate attacker to gain unauthorized access to confidential Android user data. To prevent the disclosure of user data, a device that supports unlocking must implement it properly (we've seen numerous instances where device manufacturers improperly implemented unlocking).

A properly implemented unlocking process has the following properties. When the unlocking command is confirmed by the user, the device must start an immediate data wipe. The unlocked flag must not be set until after the secure deletion is complete. If a secure deletion cannot be completed, the device must stay in a locked state. If supported by the underlying block device, ioctl(BLKSECDISCARD) or equivalent should be used. For eMMC devices, this means using a Secure Erase or Secure Trim command. For eMMC 4.5 and later, this means using a normal Erase or Trim followed by a Sanitize operation. If BLKSECDISCARD is not supported by the underlying block device, ioctl(BLKDISCARD) must be used instead. On eMMC devices, this is a normal Trim operation. If BLKDISCARD is not supported, overwriting the block devices with all zeros is acceptable. An end user must have the option to require that user data be wiped prior to flashing a partition. For example, on Nexus devices, this is done via the fastboot oem lock command. A device may record, via efuses or similar mechanism, whether a device was unlocked and/or relocked.

These requirements ensure that all data is destroyed upon the completion of an unlock operation. Failure to implement these protections is considered a moderate level security vulnerability. A device that is unlocked may be subsequently relocked using the fastboot oem lock command. Locking the bootloader provides the same protection of user data with the new custom OS as was available with the original device manufacturer OS (e.g. user data will be wiped if the device is unlocked again).

Exemplary Systems and Environments

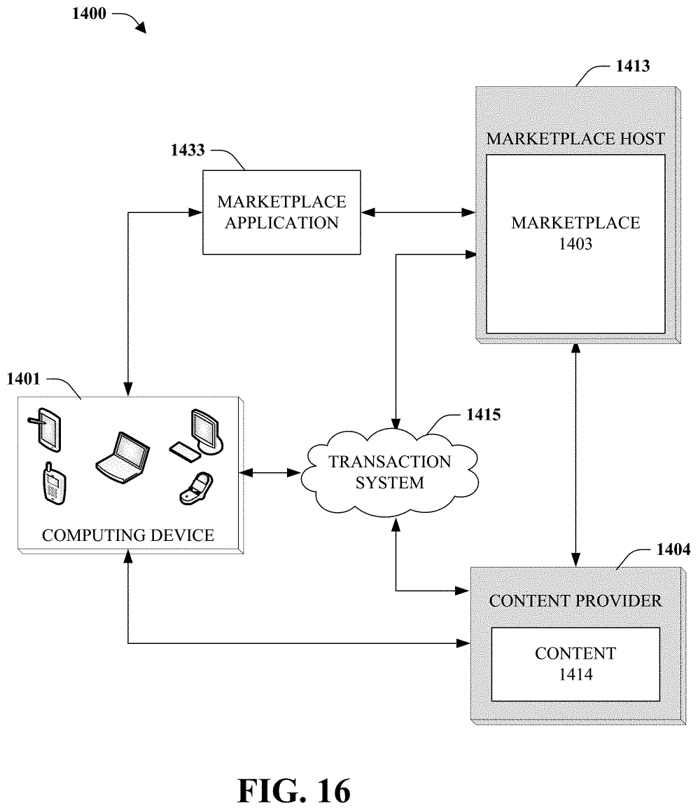

FIG. 16 illustrates an operating environment 1400 that can be used with the subject innovation. The operating environment 1400 includes a computing device 1401 (e.g., client computing device 506, device, smartphone, a tablet, a laptop, a desktop machine, a portable gaming device, a device with Internet connectivity, among others), a user, a marketplace 1403, a content provider 1404, and content 1414. The operating environment 1400 is configured to deliver data (e.g., content 1414) to the computing device 1401 based upon a request from the computing device 1401 (e.g., typically initiated by a user of the computing device 1401). However, it may be appreciated that the delivery of data to the computing device 1401 can be pushed to the computing device 1401 and further approved (e.g. acceptance of license agreement, among others) by the user. The data delivered can be from a content provider 1404, wherein the data can be delivered directly to the computing device 1401 or indirectly delivered to the computing device 1401 via the marketplace 1403 and/or the marketplace applications 1433. In an embodiment, the computing device 1401 can utilize a transaction system 1415 that facilitates purchasing data via at least one of the marketplace 1403, the marketplace applications 1433, the content provider 1404, and the like. The transaction system 1415 can be configured to utilize a charging gateway to facilitate completing a transaction between entities (e.g., user, content provider, marketplace, among others).

The computing device 1401 and the marketplace 1403 can be configured to communicate across a network, for example, wherein the marketplace 1403 is accessed via the marketplace application 1433 or a user interface (UI) associated with one of the marketplace 1403 or the marketplace host 1413. The marketplace 1403 can be hosted by a marketplace host 1413 associated with any suitable host, server, computer, data store, and the like.

In one embodiment, the computing device 1401 is mobile so that it may function for a period of time without requiring a physical connection to a power source or network provider. For example, a cellular network or a Wi-Fi connection can be used by the computing device 1401 in order to transmit and/or receive data within the operating environment 1400.

A user can employ the computing device 1401 for the device's intended functions as well as communicating data with the marketplace 1403 and/or marketplace host 1413. Commonly, the user purchases content 1414 and/or products from the content provider 1404 via the transaction system 1415. It is to be appreciated that the marketplace 1403 can be in an electronic form such as a web site, the marketplace application 1433, or an executable program. In a preferred embodiment, the marketplace 1403 takes the form of the marketplace application 1433 configured to run on the user's computing device 1401. The marketplace application 1433 may be utilized to install the content 1414 from the content provider 1404 onto the computing device 1401.

The marketplace 1403 can further connect the content provider 1404 and/or the content 1414 of the content provider 1404 with the computing device 1401 to allow the user to receive content 1414 via a download (e.g., communication of data packets). The marketplace 1403 can offer the user a variety of content 1414 for purchase (via the transaction system 115) or for free of charge. The content 1414 offered by the marketplace 1403 may also come from the marketplace host 1413. For example, the content provider 1404 can have a website for direct delivery of content 1414 or have content 1414 hosted in the marketplace 1403 by the marketplace host 1413. Thus, in such an example, a user can directly receive data or content from the web site of the content provider 1404 or use the marketplace application 1433 to identify the content 1414 for receipt through the marketplace 1403. Moreover, the content 1414 can be tailored to the computing device 1401. For instance, a first content can be built for a first computing device having a first operating system and a second content can be built for a second computing device having a second operating system, wherein the first content and the second content can be from the content provider 1404.

In some embodiments, the system 1400 utilizes the transaction system 1415. The transaction system 1415 can include a transaction gateway that facilitates transactions between at least the marketplace host 1413, one or more users, the marketplace 1403, and/or the content provider 1404. When the user purchases content 1414 from the marketplace 1403 or content provider 1404, a charging gateway can receive a request to apply a charge to a user account (e.g., a monetary value via an electronic transaction via an account) owned or authorized by the user. For example, the user account can be, but is not limited to being, a credit card account, an account with the content provider 1404 or marketplace host 1413, a bank account, a debit account, an e-commerce account (e.g. Pay-Pal®), an electronic account, a savings account, and the like.

The transaction gateway can store transaction data (e.g., user account, username, password, data related to the user, data related to the computing device 1401, among others) specific to a transaction to receive content 1414. The transaction gateway can further collect and/or store data regarding one or more users, wherein the data can be, but is not limited to, credit card numbers, to make it easier for the one or more users to engage in multiple transactions (e.g., simultaneously and/or various points in time). The transaction gateway can further reverse a transaction between one or more parties involved, such as providing a refund to the user.

It is to be appreciated that a purchase may not require the transfer of finances. For example, the content 1414 on the marketplace 1403 could be free to download. Additionally, a portion of the transaction system 1415 can be integrated into at least one of the content provider 1404, the marketplace host 1413, the marketplace application 1433, or a combination thereof. In another embodiment, the first content 1414 can be free but additional content related to the first content 1414 can require a purchase.

The content provider 1404 can create content 1414 (e.g., also referred to as products, software, apps, applications, and the like) that can be sold on the marketplace 1403. By way of example and not limitation, the content provider 1404 can be a videogame company that creates a game to be made available for download from the marketplace 1403. By way of another example and not limitation, a bank can develop a mobile banking application that is communicated to the marketplace 1403 and made available for download via the marketplace 1403. In such example, the bank is the content provider 1404. Additionally, the bank may host the mobile banking application on the bank's website for download or delivery to users. It is to be appreciated and understood that the content provider 1404 is not limited to these examples and the content provider 1404 can be any suitable entity (e.g., user, company, business, group of users, and the like) that creates or develops content 1414 to be distributed to the marketplace host 1413 for download via the marketplace 1403.

The marketplace host 1413 maintains the marketplace 1403 on a network. The marketplace host 1413 owns and/or controls a host server that contains the marketplace 1403, and provides the user access to the marketplace 1403. The marketplace host 1413 can further control an amount of bandwidth allocated to the user to download the content 1414 of the one or more content providers 1404. In a non-limiting embodiment, the marketplace host 1413 can own and/or control the marketplace 1403. In another non-limiting embodiment, the marketplace host 1413 can host the marketplace 1403 on a network to enable access by the user.

In an exemplary embodiment, a user accesses the marketplace 1403 via the marketplace application 1433 located on the computing device 1401. The computing device 1401 can have access to the network 1405, and the computing device 1401 can communicate data in the form of a query to the marketplace host 1413, wherein the data can be a request for information on content 1414. The marketplace host 1413 can communicate data in the form of a query result (which can include content 1414) via a network to the computing device 1401 for review, install, use, storage, and the like. In a non-limiting embodiment, the computing device 1401 can include a user-interface that displays the data (e.g., the query, the query result, the content 1414, among others) for the user.

Prior to download of content 1414, the user can further navigate information regarding the content 1414 that is displayed and select to either request additional content 1414 or to purchase the content 1414. If the user selects to purchase content 1414, the marketplace application 1433 communicates a purchase request to the marketplace host 1413. The marketplace host 1413 can then use the transaction system 1415 which includes the transaction gateway charging the user account if data related to the user account is available, and if the user account is not available, then the marketplace host 1413 can request user account 1412 information from the user which can then be sent to the transaction gateway. Upon receipt of the user account information, the transaction gateway can charge the user account, and send a confirmation of the transaction back to the marketplace host 1413.

The marketplace host 1413 can then communicate the confirmation information to the computing device 1401, as well as enable the user to download data for the content 1414 and/or the marketplace application 1433 stored in a host server regarding the specific content 1414 and/or marketplace application 1433 purchased. The marketplace application 1433 can further assist with installation of the content 1414 or marketplace application 1433 purchased onto the computing device 1401. It is to be appreciated and understood that the above process can occur in any order, such as a downloading of application information from the marketplace host 1413 prior to the transaction and the order of the above described process is not to be limiting on the subject innovation. It is to be appreciated that the secure link application 512 can be purchased and/or downloaded via the marketplace 1403.

One of ordinary skill in the art can appreciate that the various embodiments of a secure link application 110 described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not limited to, cloud environments with physical computing devices (e.g., servers) aggregating computing resources (i.e., memory, persistent storage, processor cycles, network bandwidth, etc.) which are distributed among a plurality of computable objects. The physical computing devices can intercommunicate via a variety of physical communication links such as wired communication media (e.g., fiber optics, twisted pair wires, coaxial cables, etc.) and/or wireless communication media (e.g., microwave, satellite, cellular, radio or spread spectrum, free-space optical, etc.). The physical computing devices can be aggregated and exposed according to various levels of abstraction for use by application or service providers, to provide computing services or functionality to client computing devices. The client computing devices can access the computing services or functionality via application program interfaces (APIs), web browsers, or other standalone or networked applications. Accordingly, aspects of the secure link application 110 can be implemented based on such a cloud environment. For example, the secure link application 110 can reside in the cloud environment such that the computer-executable instruction implementing the functionality thereof are executed with the aggregated computing resources provided by the plurality of physical computing devices. The cloud environment provides one or more methods of access to the subject innovation, which are utilized by the secure link application 110. In an embodiment, software and/or a component can be installed on a mobile device to allow data communication between the mobile device and the cloud environment. These methods of access include IP addresses, domain names, URLs, etc. Since the aggregated computing resources can be provided by physical computing device remotely located from one another, the cloud environment can include additional devices such as a routers, load balancers, switches, etc., that appropriately coordinate network data.

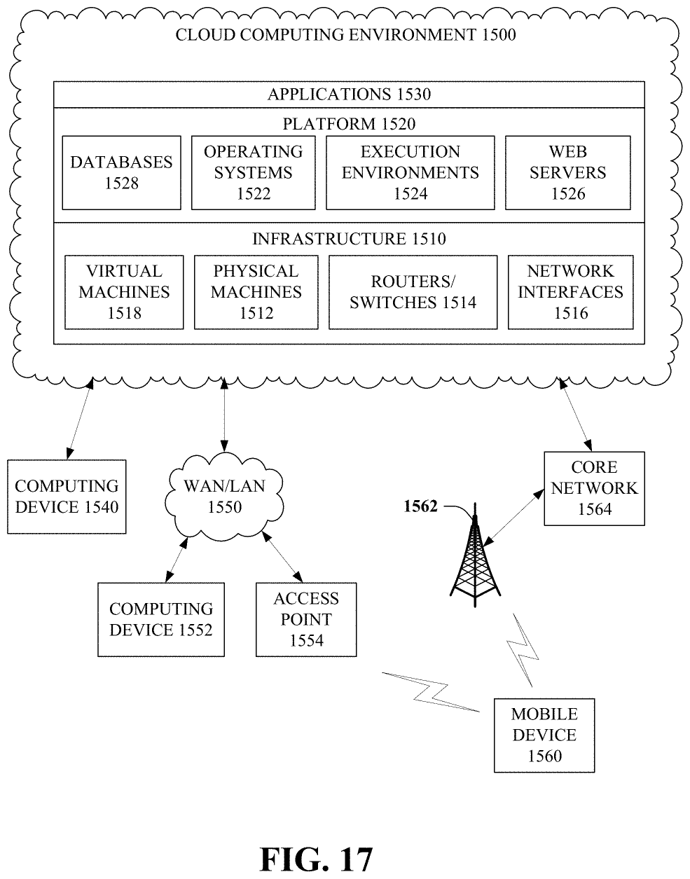

FIG. 17 provides a schematic diagram of an exemplary networked or distributed computing environment, such as a cloud computing environment 1500. The cloud computing environment 1500 represents a collection of computing resources available, typically via the Internet, to one or more client devices. The cloud computing environment 1500 comprises various levels of abstraction: infrastructure 1510, a platform 1520, and applications 1530. Each level, from infrastructure 1510 to applications 1530 is generally implemented on top of lower levels, with infrastructure 1510 representing the lowest level.

Infrastructure 1510 generally encompasses the physical resources and components on which cloud services are deployed. For instance, infrastructure 1510 can include virtual machines 1512, physical machines 1514, routers/switches 1516, and network interfaces 1518. The network interfaces 1518 provide access to the cloud computing environment 1500, via the Internet or other network, from client devices such as computing devices 1540, 1552, 1560, etc. That is, network interfaces 1518 provide an outermost boundary of cloud computing environment 1500 and can couple the cloud computing environment 1500 to other networks, the Internet, and client computing devices. Routers/switches 1516 couple the network interfaces 1518 to physical machines 1514, which are computing devices comprising computer processors, memory, mass storage devices, etc. Hardware of physical machines 1514 can be virtualized to provide virtual machines 1512. In an aspect, virtual machines 1512 can be executed on one or more physical machines 1514. That is, one physical machine 1514 can include a plurality of virtual machines 1512.

Implemented on infrastructure 1510, platform 1520 includes software that forming a foundation for applications 1530. The software forming platform 1520 includes operating systems 1522, programming or execution environments 1524, web servers 1526, and databases 1528. The software of platform 1520 can be installed on virtual machines 1512 and/or physical machines 1514.

Applications 1530 include user-facing software applications, implemented on platform 1520, that provide services to various client devices. In this regard, at least the secure link application 110 as described herein is an example application 1530. As illustrated in FIG. 15, client devices can include computing devices 1540, 1552 and mobile device 1560. Computing devices 1540, 1552 can be directly coupled to the Internet, and therefore the cloud computing environment 1500, or indirectly coupled to the Internet via a WAN/LAN 1550. The WAN/LAN 1550 can include an access point 1554 that enables wireless communications (e.g., WiFi) with mobile device 1560. In this regard, via access point 1554 and WAN/LAN 1550, mobile device 1560 can communicate wirelessly with the cloud computing environment 1500. Mobile device 1560 can also wirelessly communicate according to cellular technology such as, but not limited to, GSM, LTE, 5G, WiMAX, HSPA, etc. Accordingly, mobile device 1560 can wireless communicate with a base station 1562, which is coupled to a core network 1564 of a wireless communication provider. The core network 1564 includes a gateway to the Internet and, via the Internet, provides a communication path to the cloud computing environment 1500.

The term “component” as used herein can be defined as a portion of hardware, a portion of software, or a combination thereof. A portion of hardware can include at least a processor and a portion of memory, wherein the memory includes an instruction to execute.

While the embodiments discussed herein have been related to the systems and methods discussed above, these embodiments are intended to be exemplary and are not intended to limit the applicability of these embodiments to only those discussions set forth herein. The embodiments and discussions herein can be readily incorporated into any of these systems and methodologies by those of skill in the art.

The above examples are merely illustrative of several possible embodiments of various aspects of the present innovation, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the innovation. In addition although a particular feature of the innovation may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the innovation, including the best mode, and also to enable one of ordinary skill in the art to practice the innovation, including making and using any devices or systems and performing any incorporated methods. The patentable scope of the innovation is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the innovation has been described for purposes of illustrating the best mode known to the applicant at the time and enable one of ordinary skill in the art to practice the innovation, including making and using devices or systems and performing incorporated methods. The examples are illustrative only and not meant to limit the innovation, as measured by the scope and merit of the claims. The innovation has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the innovation is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A secured communications device, comprising:
an audio input device;
an audio output device;
a communications interface for communicating with a computing device external to the secured communications device; and
a processor configured to:
encrypt audio input received via the audio input device to generate encrypted audio;
transmit the encrypted audio via the communications interface to the computing device for communication via a communications network to a remote recipient; and
decrypt an encrypted audio stream received from the computing device via the communication device prior to playback via the audio output device.

2. The secured communications device of claim 1, wherein the communications interface is a short-range wireless communications interface.

3. The secured communications device of claim 2, wherein the processor is further configured to control the communications interface to communicate with the computing device in accordance with a headset profile.

4. The secured communications device of claim 1, further comprising a computer-readable storage medium storing a set of encryption keys.

5. The secured communications device of claim 4, wherein the processor is further configured to utilize an encryption key, selected from the set of encryption keys, to encrypt or decrypt audio,
wherein the encryption key is selected based at least in part on the remote recipient to which encrypted audio is transmitted.

6. The secured communications device of claim 1, wherein the processor is configured to encrypt the audio input after passing through an analog-to-digital converter associated with the audio input device.

7. The secured communications device of claim 1, wherein the processor is configured to decrypt the encrypted audio stream before passing through a digital-to-analog converted associated with the audio output device.

8. The secured communications device of claim 1, further comprising a housing for the audio input device, the audio output device, the communications interface, and the processor,
wherein the housing provides a portable form-factor that is separate from the computing device.

9. The secured communications device of claim 1, wherein the remote recipient includes at least a second computing device and a second secured communications device.

10. The secured communications device of claim 1, wherein communication via the communications network between the computing device and the remote recipient occurs via a voice-over-IP (VOIP) application.

11. A method, comprising:
receiving audio input, via an audio input device, from a user;
encrypting the audio input to produce an encrypted audio input stream;
transmitting the encrypted audio input stream to a computing device via a communications link;
receiving an encrypted audio output stream from the computing device via the communications link;
decrypting the encrypted audio output stream to produce an audio output; and
outputting the audio output, via an audio output device, to the user.

12. The method of claim 11, wherein the communications link is a short-range wireless communications link.

13. The method of claim 11, further comprising pairing with the computing device to establish the communications link in accordance with a headset profile.

14. The method of claim 11, further comprising:
selecting at least one encryption key from a set of encryption keys; and
utilizing the at least one encryption key selected to encrypt the audio input and decrypt the encrypted audio output stream.

15. The method of claim 14, wherein computing device transmits the encrypted audio input stream to a recipient via a communications network, and
wherein the at least one encryption key is selected based at least in part on the recipient.

16. The method of claim 15, wherein the computing device receives the encrypted audio output stream via the communications network from the recipient.

17. A non-transitory, computing-readable storage medium having stored thereon computer-executable instructions that, when executed by a processor, configure the processor to:
encrypt an audio input stream received via an audio input device to generate an encrypted audio input stream;
transmit the encrypted audio input stream, via a communications interface, to a computing device executing a communications session over a communications network with a remote recipient;
receive an encrypted audio output stream, via the communication interface, from the computing device, wherein the encrypted audio output stream originates from the remote recipient; and
decrypt the encrypted audio output stream to generate an audio output stream.

18. The non-transitory, computer-readable storage medium of claim 17, wherein the instructions further configure the processor to output the audio output stream via an audio output device.

19. The non-transitory, computer-readable storage medium of claim 17, wherein the instructions further configure the processor to establish the communications link with the computing device in accordance with a short-range wireless protocol and in accordance with a headset profile defined according to the short-range wireless protocol.

20. The non-transitory, computer-readable storage medium of claim 17, wherein the instructions further configure the processor to:
select at least one encryption key from a set of encryption keys; and
utilize the at least one encryption key to encrypt the audio input stream and decrypt the encrypted audio output stream,
wherein the at least one encryption keys is selected at least in part on the remote recipient.
